(19) United States
(12) Patent Application Publication
(10) Pub. No.: US 2019/0216154 A1
(43) Pub. Date: Jul. 18, 2019

(54) HEADWEAR WITH INTEGRATED EARPIECE

(71) Applicant: Ahead Collection Corp., Monroe, NY (US)

(72) Inventor: Devora Herskovic, Monroe, NY (US)

(21) Appl. No.: 16/249,289

(22) Filed: Jan. 16, 2019

Related U.S. Application Data
(60) Provisional application No. 62/617,763, filed on Jan. 16, 2018.

(51) Int. Cl. A42B 1/24; A41D 20/00; H04R 5/033; A41D 1/00

(52) U.S. Cl. CPC A42B 1/245; A41D 20/00; H04R 2201/023; A41D 1/002; H04R 5/0335

(57) ABSTRACT

Headwear, such as a hat, is provided that comprises a body. The body may form a hat, including a beret, beanie, or snood, or it may be some alternative form of head covering, such as a scarf. A horizontal pocket is located on an interior surface of the body of the headwear, the pocket comprising an interior compartment and an interior space outside of the interior compartment. Typically, the interior compartment of the horizontal pocket is configured to be placed adjacent a wearer's ear when the hat is worn.

### CROSS-REFERENCE TO RELATED APPLICATION

This application claims the benefit of U.S. Provisional Patent Application No. 62/617,763, filed Jan. 16, 2018, the contents of which are incorporated by reference herein in their entirety.

### FIELD OF THE INVENTION

The present invention is directed to a hat with a built in earpiece or headset for producing sounds while a user is wearing the hat.

### BACKGROUND

People often enjoy listening to music or otherwise using audio devices while performing a variety of activities. For example, people may enjoy talking on the phone. During such activities, it may be convenient to have earpieces placed adjacent a person's ear.

Traditional headphones, such as over the ear headphones or in ear or around the ear headphones may be impossible or uncomfortable to wear while wearing a hat or other head covering, such as scarves or the like.

### SUMMARY

Headwear, such as a hat, is provided that comprises a body. The body may form a hat, including a beret, beanie, or snood, or it may be some alternative form of head covering, such as a scarf. A horizontal pocket is located on an interior surface of the body of the headwear, the pocket comprising an interior compartment and an interior space outside of the interior compartment. Typically, the interior compartment of the horizontal pocket is configured to be placed adjacent a wearer's ear when the hat is worn.

The interior compartment may be separated from the remainder of the interior space by stitching which may partially divide an interior of the horizontal pocket.

The headwear may further comprise at least one audio earpiece located inside the interior compartment, such that the interior compartment maintains a position of the audio earpiece. In a typical embodiment, two horizontal pockets may be provided, each extending in opposite directions along the interior surface of the headwear, such that each retains a separate audio earpiece for stereo sound. Wiring for the audio earpiece (or earpieces) may then be located inside the interior space of the horizontal pocket.

The audio earpiece typically comprises a speaker and receiver for receiving an audio signal. The receiver may be, for example, a Bluetooth receiver. The audio earpiece may be audible speakers or may be a bone conduction device. The audio earpiece may further comprise a microphone for recording audio from a user, and the receiver may use a protocol for two way communication.

The audio earpiece may be removable from within the horizontal pocket.

In some embodiments, where two horizontal pockets are provided, each pocket has an opening at a first end adjacent the back of a wearer's head, and the interior compartments are at a second end of the horizontal pockets opposite the first end, and the interior compartments are configured to be located adjacent a wearer's ears when the headwear is worn.

The openings of the horizontal pockets may overlap, in such a scenario, such that a user may have to reach through both pockets in order to retrieve an earpiece from an interior compartments. Accordingly, an earpiece may be located in interior compartments associated with each horizontal pockets, while wiring may be located in the interior space outside the interior compartments for each such pocket.

In some embodiments, a first of two audio earpieces located within a first of the interior compartments includes both a receiver for receiving an audio signal and a first sound transducer, while a second earpiece located within a second of the interior compartments comprises a second sound transducer for generating sounds based on the audio signal.

### BRIEF DESCRIPTION OF THE DRAWINGS

FIG. 1A is a front view of a hat according to an embodiment of this disclosure.

FIG. 1B is a side view of the hat of FIG. 1A.

FIG. 2 is a schematic diagram showing an interior section of the hat of FIGS. 1A and 1B.

FIG. 3 is a second schematic diagram showing the interior section of FIG. 2.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

As discussed below, the embodiments are shown and described with respect to specific hat, but the hat can be any headwear configured to surround at least a portion of a wearer's head. Such articles of headwear include the hat shown, generally a beret, as well as headbands, beanies, dress hats designed to cover a wearer's ears, sleep caps, handkerchiefs, snoods, and the like. Some hat designs may include a cord, such as an elastic cord, for adjusting the hat and securing the hat to a wearer's head. Similarly, such hats may be made of any of a wide variety of materials.

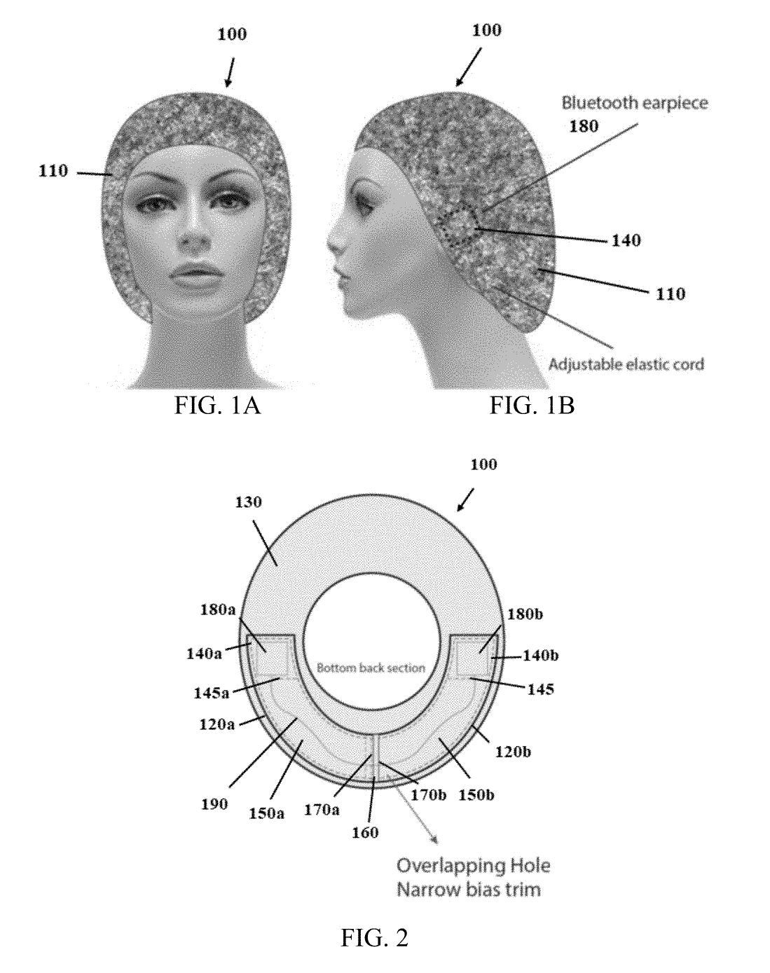

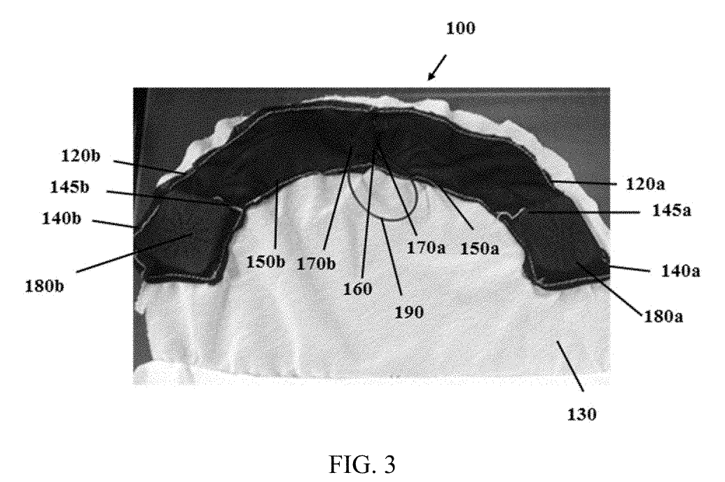

FIG. 1A is a front view of a hat 100 according to an embodiment of this disclosure. FIG. 1B is a side view of the hat 100 of FIG. 1A with an interior compartment 140 marked schematically. FIGS. 2 and 3 are schematic diagrams showing an interior section of the hat 100 of FIGS. 1A and 1B.

As shown, the hat 100 has a body 110 and horizontal pockets 120a, b on an interior surface 130 of the hat. Each horizontal pocket 120 has an interior compartment 140a, b and an interior space 150a, b outside of the interior compartment.

Each interior compartment 140a, b of the horizontal pocket 120a, b is configured to be placed adjacent a wearer's ears when the hat 100 is worn. As shown, the hat 100 typically includes two horizontal pockets 120a, b, with each extending in opposite directions from a central point 160 at a back of the hat 100. Accordingly, each of the horizontal pockets has an opening 170a, b at a first end of the horizontal pocket 120a, b and an interior compartment 140a, b at a second end of the horizontal pocket. In such an embodiment, the opening 170 of each horizontal pocket 120 is typically configured to be adjacent a back of a user's head when the hat 100 is worn, and interior compartments 140 are configured to be adjacent the user's ears.

The interior compartment 140 may be divided from the interior space 150 of the corresponding horizontal pocket 120 by stitching 145a, b. Such stitching 145 may partially divide an interior of the horizontal pocket.

An audio earpiece 180 is typically located inside each of the interior compartments 140, and the interior compartment locates the audio earpiece adjacent the wearer's ears and maintains the position of the audio earpiece. Wiring 190 associated with the audio earpiece 180 may be located within the interior space 150. Typically, the audio earpiece 180 is removable from the interior compartment 140.

The audio earpiece 180 typically includes a speaker or some other type of sound transducer or a bone conduction device for generating sounds and a receiver for receiving an audio signal. Such a receiver may be a wireless receiver, such as a Bluetooth receiver for connecting to a user's audio device, such as a smartphone. In some embodiments, the audio earpiece may further comprise a microphone, and the wireless receiver may be configured for two way communications. In such an embodiment, the microphone may transmit audio, using the wireless receiver using a standard protocol, such as Bluetooth. Such a configuration would allow, for examples, users of the hat to talk on the phone hands free.

In embodiments where two audio earpieces 180a, b are provided, one for each ear, each audio earpiece may be placed within a corresponding interior compartment 140a, b, and the wiring 190 may run from a first of the earpieces 180a to a second 180b within the interior space 150a, b of the two horizontal pockets 120. Where two earpieces are present, a first of the earpieces 180a may contain both device for generating sounds, such as a speaker, and a receiver for receiving an audio signal, while a second of the earpieces 180a may contain only a speaker and may be provided with the audio signal from the first earpieces.

In some embodiments, each of the earpieces 180 may contain only a speaker and the earpieces 180 may be connected directly to an audio device or an external receiver for receiving audio signals.

In some embodiments, the openings of the horizontal pockets 120a, b, overlap each other such that the wiring 190 is not visible once placed inside the pockets.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. Headwear comprising:
a body;
at least one horizontal pocket on an interior surface of the body;
the pocket comprising an interior compartment and an interior space outside of the interior compartment.

2. The headwear of claim 1, wherein the headwear is a hat, and the interior compartment is configured to be placed adjacent a wearer's ear when the hat is worn.

3. The headwear of claim 2, wherein the hat is a beret, beanie, or snood.

4. The headwear of claim 1, wherein the interior compartment is separated from the interior space by stitching partially dividing an interior of the horizontal pocket.

5. The headwear of claim 1, further comprising at least one audio earpiece inside the interior compartment, the interior compartment maintaining a position of the audio earpiece, and wiring for the audio earpiece inside the interior space.

6. The headwear of claim 5, the at least one audio earpiece comprising a speaker and a receiver for receiving an audio signal.

7. The headwear of claim 6, wherein the receiver is a Bluetooth receiver.

8. The headwear of claim 5, wherein the at least one audio earpiece is speakers or bone conduction devices.

9. The headwear of claim 5, wherein the audio earpiece further comprises a microphone for recording audio from a user, and wherein the receiver uses a protocol for two way communication.

10. The headwear of claim 5, wherein the at least one audio earpiece is removable from within the horizontal pocket.

11. The headwear of claim 1, wherein the at least one horizontal pocket is two horizontal pockets, each extending in opposite directions along the interior surface of the headwear.

12. The headwear of claim 11, wherein each of the horizontal pockets has an opening at a first end adjacent the back of a wearer's head and wherein the interior compartments are at a second end of the horizontal pockets opposite the first end, and wherein each of the interior compartments are configured to be placed adjacent the wearer's ears when the headwear is worn.

13. The headwear of claim 12, wherein the openings of the horizontal pockets overlap each other adjacent the back of the wearer's head when the headwear is worn.

14. The headwear of claim 13 further comprising an audio earpiece within each of the interior compartments and wiring within the interior space of each of the two horizontal pockets connecting the audio earpieces, the interior compartments maintaining the locations of the audio earpieces.

15. The headwear of claim 14, wherein a first of the audio earpieces within a first of the interior compartments includes a receiver for receiving an audio signal and a first sound transducer for generating sounds based on the audio signal, and a second of the audio earpieces within a second of the interior compartments comprises a second sound transducer for generating sounds based on the audio signal.

16. The headwear of claim 14 wherein the audio earpieces are removable from within the horizontal pockets.
